(19) United States
(12) Patent Application Publication
(10) Pub. No.: US 2013/0124693 A1
(43) Pub. Date: May 16, 2013

(54) SYSTEM, METHOD, AND DEVICE FOR EXECUTING A COMPOSITE SERVICE

(71) Applicants: Ryoji Kato, Kanagawa (JP); Toshikane Oda, Tokyo (JP); Johan Kristiansson, Lulea (SE); Ioannis Fikouras, Stockholm (SE)

(72) Inventors: Ryoji Kato, Kanagawa (JP); Toshikane Oda, Tokyo (JP); Johan Kristiansson, Lulea (SE); Ioannis Fikouras, Stockholm (SE)

(73) Assignee: Telefonaktiebolaget L M Ericsson (publ), Stockholm (SE)

(21) Appl. No.: 13/704,878

(22) PCT Filed: Jul. 23, 2010
(86) PCT No.: PCT/JP2010/062967

§ 371 Date: Dec. 17, 2012

(51) Int. Cl. H04L 29/08

(52) U.S. Cl. CPC H04L 67/06
USPC 709/219

(57) ABSTRACT

A system for executing a composite service formed by a plurality of software components, the plurality of software components including a first software component and a second software component which is referred from the first software component is provided. The system includes an execution unit configured to execute the first software component; a specification unit configured to specify address information to be used for downloading the second software component and a target device intended to execute the second software component; and a deployment unit configured to deploy the second software component down-loaded by use of the address information to the target device. The deployment unit is configured to deploy the second software component while the execution unit is executing the first software component so that the execution unit can call the second software component.

### TECHNICAL FIELD

The present invention relates to a system, a method and a device for executing a composite service.

### BACKGROUND

SOA (Service-Oriented Architecture) is a set of design principles for service development and integration. One of principle is a service composability that requires that collections of services can be coordinated and assembled to form a composite service. To enable composite services, SCA (Service Component Architecture), whose design is conformed to SOA, is an important artifact and advocated by major software vendors. A specification titled “SCA Assembly Model”, which was published by Open SOA, describes how the service components are assembled to one composite service. FIG. 11 illustrates a basic diagram of a composite service. A component A 1110 and a component B 1120 are tied to create the Composite A 1100. As shown in FIG. 11, the Composite A 1100 is created by wiring a Service 1121 of the Component B 1120 and a Reference 1111 of the Component A 1110. The Service 1121 represents functions that the Component B 1120 provides for other components. The Reference 1111 represents dependency of the Component A 1110 to a Service provided by another component. While the Component A 1110 is executed, the Component B 1120 is called from the Component A 1110 and returns the execution result to the Component A 1110.

A whitepaper titled “Power Combination: SCA, OSGi and Spring”, which was also published by Open SOA, describes how OSGi service is combined with Service Component defined in SCA. OSGi is a de-facto technology for adding dynamic modular software loading system on top of Java technology and for enabling Java Virtual Machine (JVM) to dynamically install, uninstall, and update applications on JVM without rebooting the system. OSGi can make the users easily download and install a piece of software (referred as a “bundle” in OSGi) because OSGi automatically downloads and installs the other necessary software such as libraries and/or services that are required by the software which the user downloads.

FIG. 12 illustrates how SCA and OSGi services are integrated. FIG. 12 illustrates some combinations of SCA Components and OSGi service. One of the combinations is a combination between a SCA Component (“Component X”) and an OSGi service in remote host (“Service A”). The Component X communicates with the Service A via a SCA Component (“Reference SOAP Binding Service A”) and an OSGi service (“SOAP bundle”). Both enable to loose coupling between the Component X and the Service A.

It is beneficial for mobile service operators if a composite service can orchestrate the applications running on users' devices such as mobile phones. For example, the orchestrated service on the user's device can collect information about other devices in user's local personal area network or can interact with end-users, those of which will contribute to develop attractive service for mobile service operators.

FIG. 13 illustrates a situation for such composite services that orchestrate services on users' devices. According to the existing technologies, an application 1321 has to be downloaded to the user device 1310 from an application warehouse 1320 and deployed on the user device 1310 before the application 1321 is called from a component 1301 of a composite service running on a SCA container 1300. The composite service can be applied only to such devices that has downloaded and deployed the application 1321 in advance. According to an existing technique, a component to be called from another component must be deployed in advance well before execution of the intended composite service. In addition, a target application to be combined cannot be downloaded on-demand by the composite service so that dynamic download of applications can be enabled.

### SUMMARY

According to an aspect of the invention, a system for executing a composite service formed by a plurality of software components, the plurality of software components including a first software component and a second software component which is referred from the first software component is provided. The system includes an execution unit configured to execute the first software component; a specification unit configured to specify address information to be used for downloading the second software component and a target device intended to execute the second software component; and a deployment unit configured to deploy the second software component downloaded by use of the address information to the target device. The deployment unit is configured to deploy the second software component while the execution unit is executing the first software component so that the execution unit can call the second software component.

Further features of the present invention will become apparent from the following description of exemplary embodiments with reference to the attached drawings.

### BRIEF DESCRIPTION OF DRAWINGS

FIG. 1 illustrates an exemplary environment including a system 100 for executing a composite service according to an embodiment of the present invention.

FIG. 2 illustrates division of the Service and Reference.

FIG. 3 illustrates how a first software component calls a second software component by using Service-Reference model.

FIG. 4 illustrates details of the SCA container 116 and OSGi container 126 in FIG. 1 according to an embodiment of the present invention.

FIG. 5 illustrates details of the SCA container 116 and OSGi container 126 in FIG. 1 according to another embodiment of the present invention.

FIG. 6 illustrates exemplary overall operations performed in the configuration described in FIGS. 1 and 5 according to an embodiment.

FIG. 7 illustrates other exemplary overall operations performed in the configuration described in FIGS. 1 and 5 according to an embodiment.

FIG. 8 illustrates another exemplary environment including a system 100 for executing a composite service according to an embodiment of the present invention.

FIG. 9 illustrates exemplary overall operations performed in the configuration described in FIGS. 5 and 8 according to an embodiment.

FIG. 10 illustrates a service deployment table.

FIG. 11 illustrates a basic diagram of a composite service.

FIG. 12 illustrates how SCA and OSGi services are integrated.

FIG. 13 illustrates a situation for such composite services that orchestrate services on users' devices.

### DETAILED DESCRIPTION

Embodiments of the present invention will now be described with reference to the attached drawings. Each embodiment described below will be helpful in understanding a variety of concepts from the generic to the more specific. It should be noted that the technical scope of the present invention is defined by claims, and is not limited by each embodiment described below. In addition, not all combinations of the features described in the embodiments are always indispensable for the present invention.

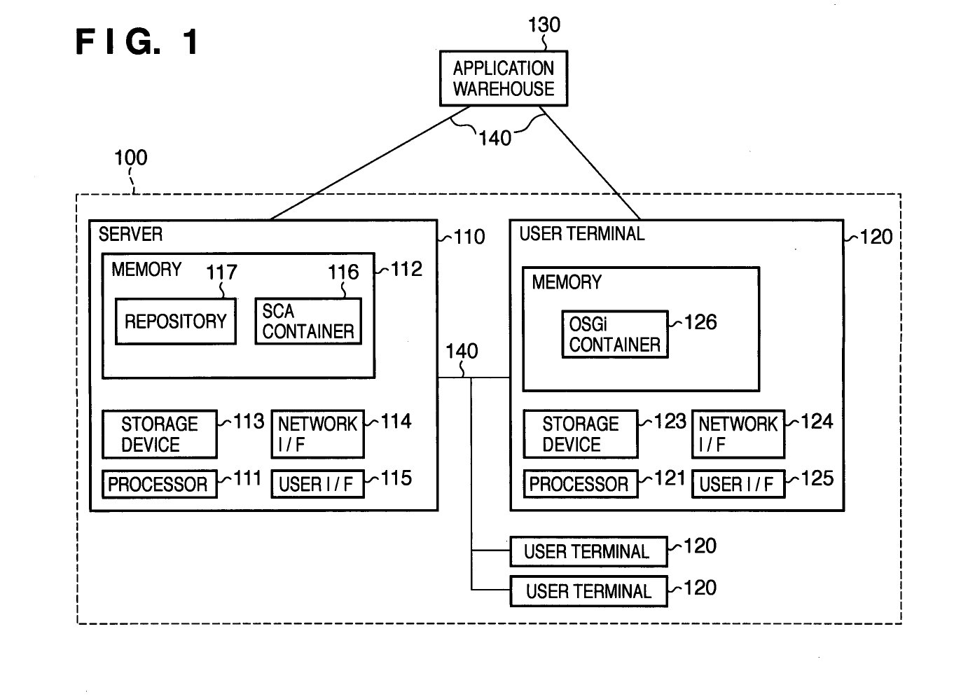

FIG. 1 illustrates an exemplary environment including a system 100 for executing a composite service according to an embodiment of the present invention. The composite service is a service formed by a plurality of software components. The software component may be a piece of computer program and is also referred as a component, a service component, or an application hereinafter. The system 100 includes a server 110, a user terminal 120, and an application warehouse 130. The system 100 may include a plurality of user terminals 120. The server 110, the user terminal 120, and the application warehouse 130 may be communicated with each other via a network 140. The network 140 may be a wireless network such as WLAN, a GSM network, and the like or a wired network such as MAN, WAN, and the like. The network 140 may be a public network such as the Internet or a managed network such as an IMS network.

The server 110 may include a processor 111, a memory 112, a storage device 113, a network interface (I/F) 114, and a user interface (I/F) 115. The server 110 may be included in an operator network and be used by an operator to execute a composite service. The processor 111 is for example a CPU or a microprocessor and controls overall operations of the server 110. The memory 112 stores computer programs and data used for operations of the server 110. The memory 112 is also used for deployment of a SCA container 116. The SCA container 116 deployed on the memory 112 may cooperate with the processor 111 to act as an execution unit in the server 110. The memory 112 may store a repository 117, details of which will be described later. The storage device 113 may be implemented by an HDD, for example, and operate as a database. The network interface 114 provides functions for transmitting and receiving data to/from other devices. The user interface 115 provides functions for presenting and obtaining data to/from a user of the server 110 and may be implemented by a display, a keyboard, and the like.

The user terminal 120 may include a processor 121, a memory 122, a storage device 123, a network interface (I/F) 124, and a user interface (I/F) 125. The user terminal 120 is a device used by a user, such as a mobile phone, a personal computer, a PDA, and the like. The processor 121 is for example a CPU or a microprocessor and controls overall operations of the user terminal 120. The memory 122 stores computer programs and data used for operations of the user terminal 120. The memory 122 is also used for deployment of an OSGi container 126. The OSGi container 126 deployed on the memory 122 may cooperate with the processor 121 to act as an execution unit in the user terminal 120. The storage device 123 may be implemented by an HDD, for example, and operate as a database. The network interface 124 provides functions for transmitting and receiving data to/from other devices. The user interface 125 provides functions for presenting and obtaining data to/from a user of the user terminal 120 and may be implemented by a display, a keyboard, and the like.

The application warehouse 130 is an application provider that registers and stores software components and provides the software components to the user terminal in response to a request.

The present invention is not limited to the SCA container 116, but any execution environment for composite services (for example, Ericsson Composition Engine) can replace the SCA container 116. Thus, the SCA container 116 may be referred as a Service Composition (SC) Framework.

The present invention is also not limited to the OSGi container 126, but and any application framework can replace the OSGi container 126. Thus, the OSGi container 126 may be referred as an Application Framework. For example, according to an embodiment, Ajax (shorthand for asynchronous JavaScript and XML) applications are used. Ajax is a group of interrelated web development techniques used on the client-side to create interactive web applications. With Ajax, web applications can retrieve data from the server asynchronously in the background without interfering with the display and behavior of an existing page. The use of Ajax techniques has led to an increase in interactive or dynamic interfaces on web pages. Data are usually retrieved using the XMLHttpRequest object.

According to an embodiment shown in FIG. 1, the SCA container 116 and the OSGi container 126 are deployed separately on different devices (that is, the server 110 and the user terminal 120). However, the SCA container 116 and the OSGi container 126 may be deployed on the same device.

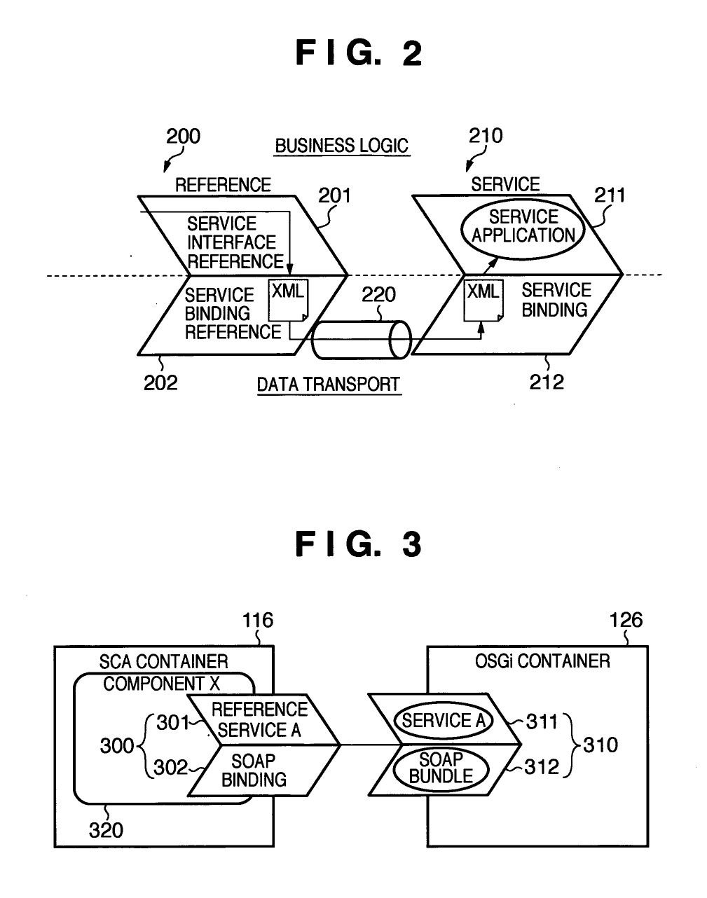

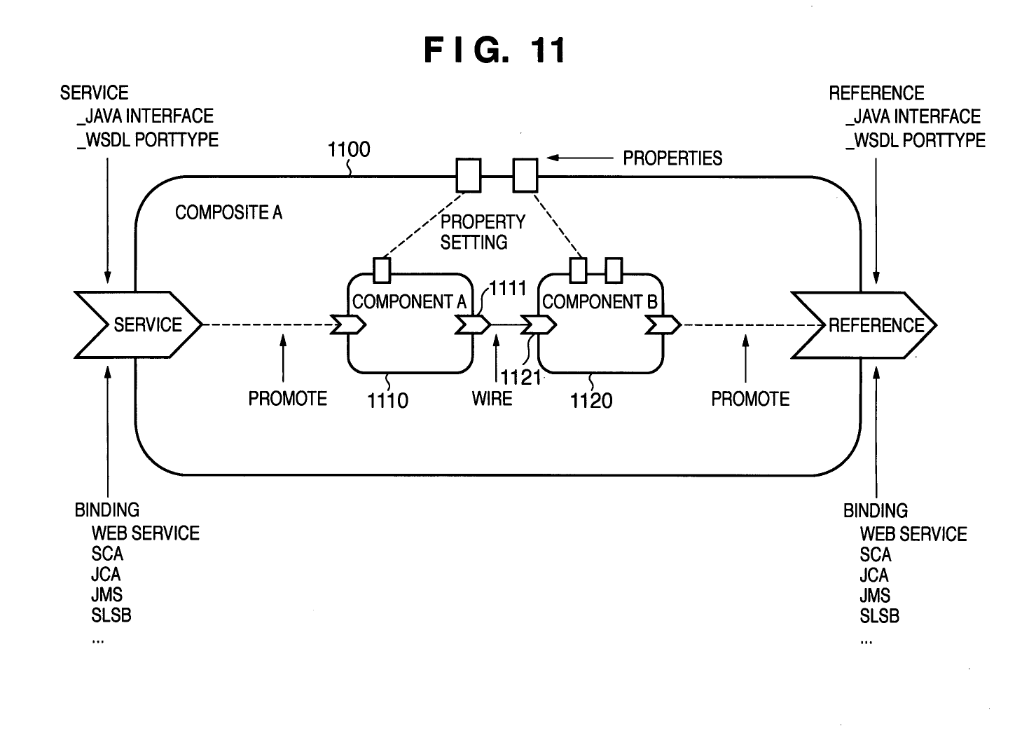

FIG. 2 illustrates division of the Service and Reference. Both the Service and Reference described earlier with reference to FIG. 11 can be divided into an Interface part such as Java interface, WSDL PortType and a Binding part such as Web Service, SCA, JCA (J2EE Connector Architecture), JMS (Java Message Service), and SLSB (Stateless Session Bean). The Interface part defines one or more business logics (business functions) of the software component such as what service is called with what parameters, and the Binding part describes the access mechanism that a software component uses to call a service in another software component such as how the parameters are transferred to the target service.

Thus, the business logic represented by the composite service is defined by Interface parts and their combination, and the logic is independent from the Binding parts of the Service and Reference of the composite service.

In terms of the development of business logic, the process of software deployment should be handled in the lower layer (that is, outside of the business logic development). It is not the expected role for developers of business logic. It is because such lower-layer process is not related to the objective of the service and it should not expect the developers to know the detailed knowledge of applications (for example, which application provides which service, which application can be downloadable from which server). The Interface part of the software component is independent of what software component is called and depends on the business logic.

In FIG. 2, the Reference 200 is divided into an Interface part 201 and a Binding part 202. The Reference 200 defines a notation of Service, which will be interpreted by an execution environment of a composite service. In case of WSDL, WSDL PortType tag corresponds to the Interface part 201 and WSDL Binding and Service tags correspond to the Binding part 202. The Service 210 is divided into an Interface part 211 and a Binding part 212. For example, in the case that GlassFish corresponds to the Binding part 212, Java Servlet corresponds to the Interface part 211. However, in general, one monolithic application can comprise both parts 211, 212.

In reference to FIG. 2, how the Service 210 is called through the Reference 200 is described. When a composite service calls the Service 210 with parameters as input data (or arguments), the execution environment of the composite service encodes these parameters to a specific data format, for example XML, REST, which is defined by the Binding part 202. This encoded data is transferred to the Service 210 over the protocol 220, for example SOAP, HTTP, JMS, which is also defined by the Binding part 212. When the Binding part 212 of the Service 210 receives the encoded data, the Binding part 212 decodes the encoded data into parameters that will be as same as those in the Reference 200. The Service Application written in Java, C++, or PHP, for example is called with these parameters.

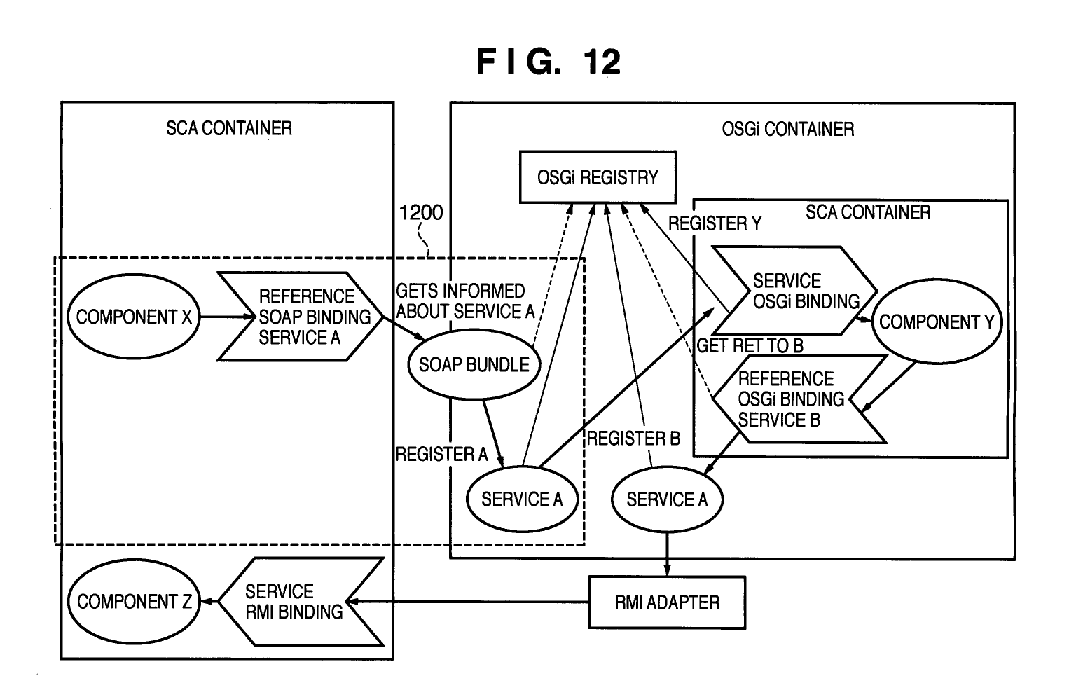

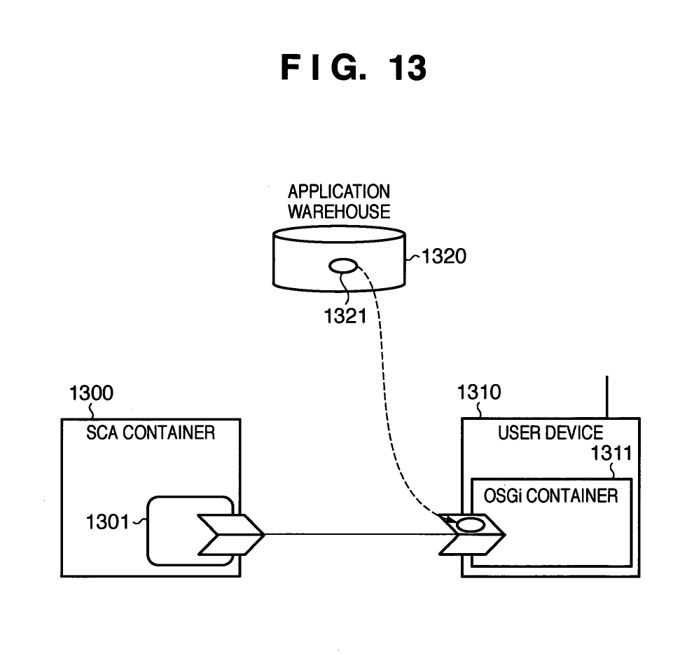

FIG. 3 illustrates how a first software component calls a second software component by using Service-Reference model. FIG. 3 focuses on the region 1200 in FIG. 12. The SCA container 116 includes a Component X 320 as a first software component and a Reference 300 of the Component X 320 is divided into an Interface part 301 and a Binding part 302. The “Reference SOAP Binding Service A” in FIG. 12 is divided into a “Reference Service A” and a “SOAP Binding”. The “Reference Service A” is included in the Interface part 301 and the “SOAP Binding” 302 is included in the Binding part 302.

The OSGi container 126 includes a Service 310 as a second software component and the Service 310 is divided into an Interface part 311 and a Binding part 312. The “Service A” in FIG. 12 is included in the Interface part 311 and the “SOAP bundle” in FIG. 12 is included in the Binding part 312. In this example, SOAP is used for the Binding parts 302, 312, but another method such as HTTP, JSM, JSON, SIP, and the like may be used for the Binding parts 302, 312 without impacts on the Interface part 301 of the Component X 320. It is also noted that the Service A and SOAP bundle are not necessarily instantiated at the time when a composite service that uses the Component X 320 is developed. A reference to the Service A provides enough information about the business logic for developers/composers.

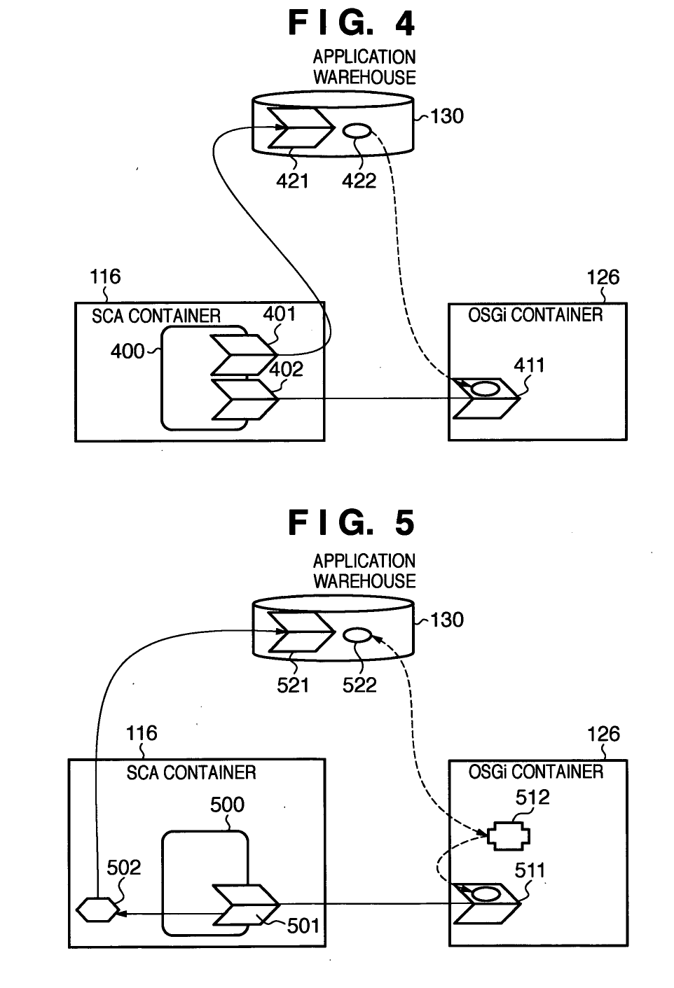

FIG. 4 illustrates details of the SCA container 116 and OSGi container 126 in FIG. 1 according to an embodiment of the present invention. The SCA container 116 includes a software component 400 including References 401, 402. When the application warehouse 130 opens the service API 421 that enables external devices to order to download an application (or a software component) to the user terminal 120, it becomes possible for the composite service to use the service API 421 in order to make a target application 422 in the application warehouse 130 downloaded and deployed on the user terminal 120 before calling the service. The Reference 401 requests the service API 421 to download the application 422 to the user terminal 120. After the application 422 is deployed on the user terminal 120, the Reference 402 calls the Service 411 which includes deployed application 422.

FIG. 5 illustrates details of the SCA container 116 and OSGi container 126 in FIG. 1 according to another embodiment of the present invention. The SCA container 116 includes a software component 500 and a DSD (Dynamic Software Deployment) agent 502. The software component 500 deployed on the server 110 and an application (or software component) provided by the application warehouse 130 form a composite service which is executed by the SCA container 116 in the server 110. The software component 500 refers the application 522 so that the software component 500 calls the application 522. The DSD agent 502 interprets and activates the Binding part of the software component 500. The DSD agent 520 can interpret a notation of a DSD Binding (which will be described below) and performs dynamic software deployment. The dynamic software deployment may be defined as a deployment of a second software component to a target device while executing a first software component which calls the second software component. The DSD agent 520 enables to invoke an application download with using the information provided by the DSD binding. The DSD agent 502 deployed on the memory 112 may cooperate with the processor to act as a specification unit in the server 110.

The Binding part 501 of the software component 500 may be called a DSD Binding when the Binding part 501 provides the information required for dynamic software deployment. In other word, the Binding part 501 may be called a DSD Binding when the Binding part 501 includes address information to be used for downloading the application 522. The DSD Binding may also describe how the application is downloaded to the user terminal 120 and deployed. The address information to be used for downloading the application 522 may include URL or URI to the application 522, IP address of the application warehouse 130, protocol required for access to the application warehouse 130, a file name of the software component, and/or the like. Because the information required for the dynamic software deployment is enclosed in the DSD Binding and the DSD Binding is executed by the DSD agent 502, the business logic remains same even if the dynamic software deployment is performed. The user terminal 120 does not need to download the software in advance before receiving the service call from the SCA Container 116.

The OSGi container 126 includes a Service 511 and a DSD remote agent 512. The DSD remote agent 512 receives a software component to be downloaded and deploy the downloaded software component on the Service 511 in the user terminal 120. The DSD remote agent 512 deployed on the memory 122 may cooperate with the processor 121 to act as a deployment unit in the user terminal 120.

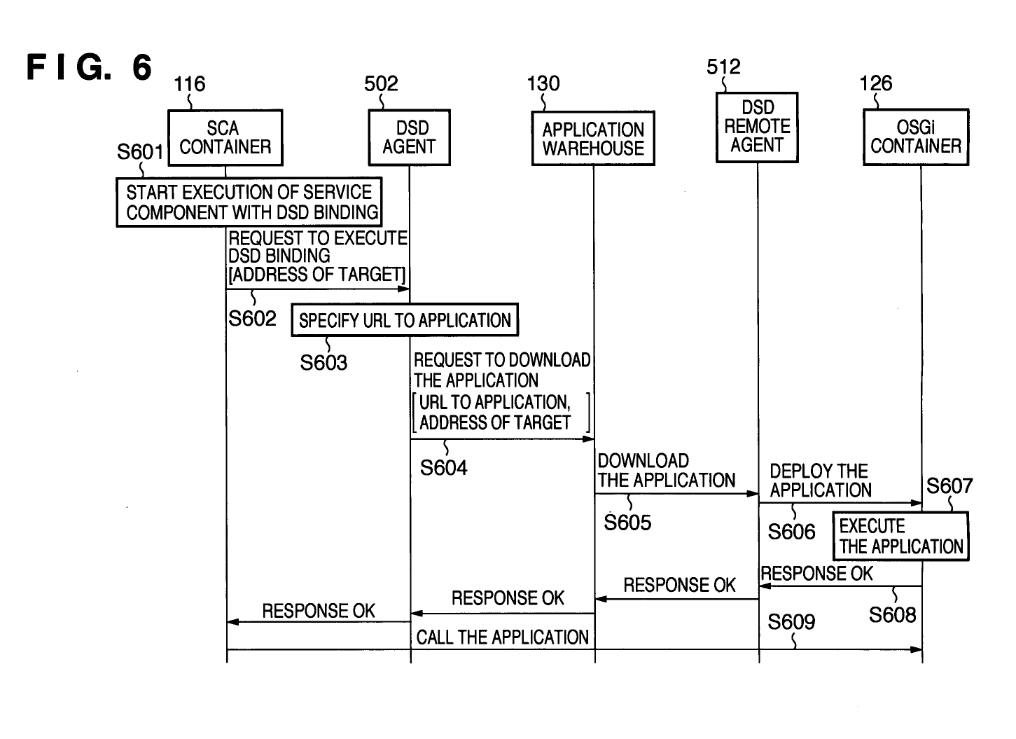

FIG. 6 illustrates exemplary overall operations performed in the configuration described in FIGS. 1 and 5 according to an embodiment. The processor included in each device executes computer programs stored in memory of each device to process these operations.

In step S601, the SCA container 116 starts execution of the software component 500 forming a composite service. According to this embodiment, the Binding port 501 of the software component 500 is a DSD Binding described above. The composite service defines that the software component 500 uses a result of the application 522 executed on the user terminal 120. Hereinafter, a user terminal 120 intended to execute the application 522 is referred as a target device. The information for specifying a target device among from the user terminals 120 (hereinafter, the target information) may be input as a parameter for executing the composite service. Note that the Interface part of the software component 500 is independent of the target device because the binding is defined in the Binding part 501 of the software component 500. The target information may include a unique identify of the user terminal 120 such as a telephone number and IMSI (international mobile subscriber identity), protocols supported by the user terminal 120, and/or the like.

In step S602, the SCA container 116 detects that the Binding part 501 of the software component 500 is a DSD Binding, and requests the DSD agent 502 to execute the dynamic software deployment according to the DSD Binding. In step S603, the DSD agent 502 specifies the address information to be used for downloading the application 522 and the user terminal 120 intended to execute the application 522, with reference to the Binding port 501 of the software component 500 and the target information.

In step S604, the DSD agent 502 sends the address information and the target information to the application warehouse 130 and requests the application warehouse 130 to download the application 522 specified the address information on the user terminal 120 with reference to the address information of the application 522, for example using the API interface 521 provided by the application warehouse 521. In step S605, the application warehouse 130 downloads the application 522 to the user terminal 120 with reference to the target information. In step S606, the DSD remote agent 512 deploys the downloaded application 522 to the Service 511 in the user terminal 120.

In step S607, the OSGi container 126 executes the deployed application 522 and prepares the executed application 522 to be called from the server 110. In step S608, the OSGi container 126 notifies the SCA container 116 in the server 110 of the successful deployment of the application 522 via the DSD remote agent 512, the application warehouse 130, and the DSD agent 502. In step S609, the SCA container 116 calls the application 522 deployed on the user terminal 120 and the OSGi container 126 executes the deployed application 522.

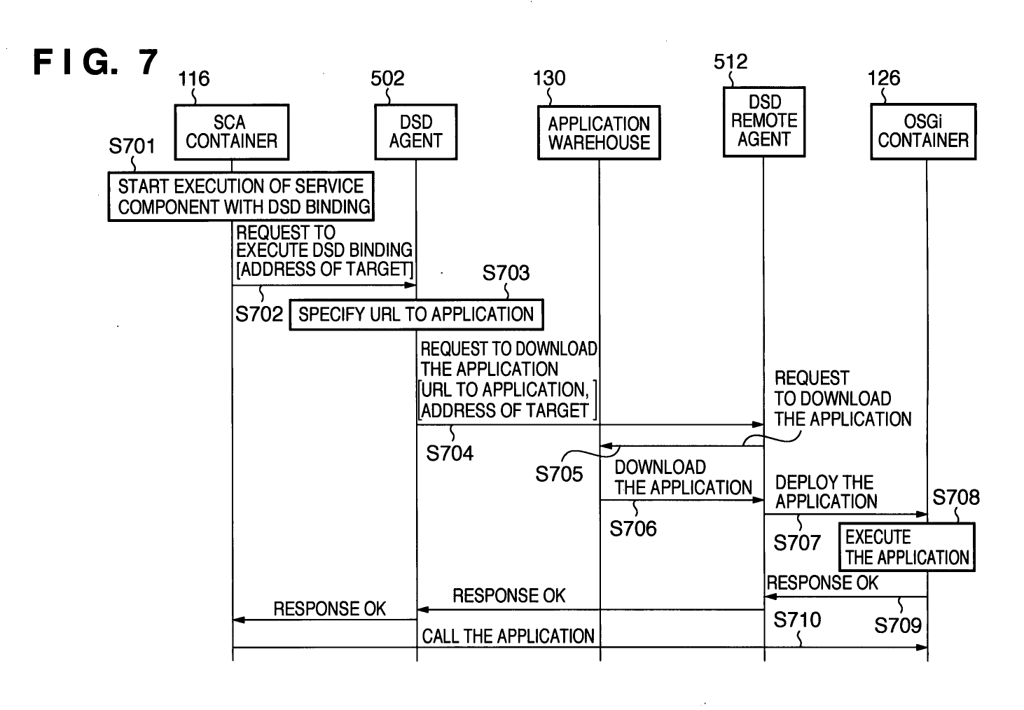

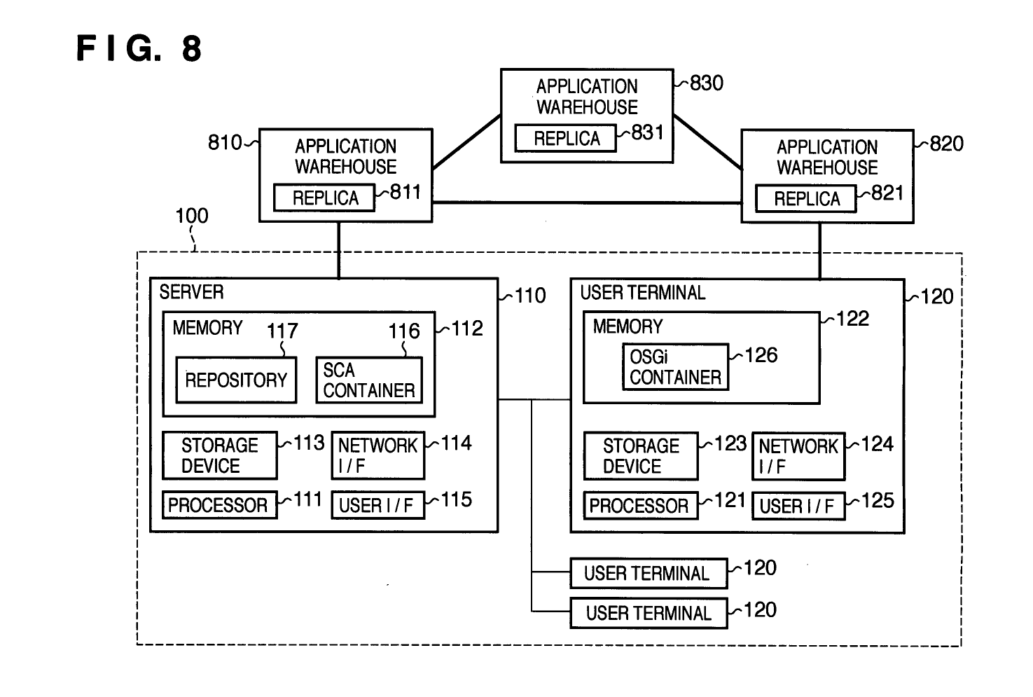

FIG. 7 illustrates other exemplary overall operations performed in the configuration described in FIGS. 1 and 5 according to an embodiment. The processor included in each device executes computer programs stored in memory of each device to process these operations. The steps S701-S703 and S707-S710 are similar to steps S601-S603 and S606-S609 respectively, and thus explanations of these steps are omitted.

In step S704, the DSD agent 502 sends the address information and the target information to the DSD remote agent 512 and requests the DSD remote agent 512 in the user terminal 120 to download and deploy the application 522 from the application warehouse 130. The DSD remote agent 512 receives the address information and the target information using the network interface 124. In step S705, the DSD remote agent 512 requests the application warehouse 130 with reference to the address information to download the application 522. In step S706, the application warehouse 130 downloads the application 522 to the user terminal 120.

FIG. 8 illustrates another exemplary environment including a system 100 for executing a composite service according to an embodiment of the present invention. The system 100 in FIG. 8 is similar to the system 100 in FIG. 1, but the configuration of the application warehouse is different. In FIG. 8, there are a plurality of application warehouses 810, 820, 830, each of which includes a replica 811, 821, 831 of the common database for managing the plurality of software components. According to the example in FIG. 8, the server 110 can communicate with the replica 811 in the application warehouse 810 and the user terminal 120 can communicate with the replica 821 in the application warehouse 820. The replicas 811, 821, 831 are synchronized with each other. To improve scalability, optimistic replication can be used to synchronize different replicas 811, 821, 831. This means that different replicas 811, 821, 831 can have different state at different times, and will only converge after the system has been idle for some time. This is beneficial from a deployment a point of view as different user terminals 120 may be connected to high latency networks or even be disconnected, which can make it hard to establish connections and also make it complicated to synchronize the replicas 811, 821, 831. When using optimistic replication and if a client loses network connection for some reason, the client will try to reconnect and synchronize its replica. The client will then be notified about missed service deployments and invoke the corresponding services, for example initialize the service and making it ready to be used. This makes much easier to deploy service to multiple clients, as the underlying synchronization framework takes care of the distribution and the SCA container 116 only have to perform one single deployment operation, which is updating the service deployment table.

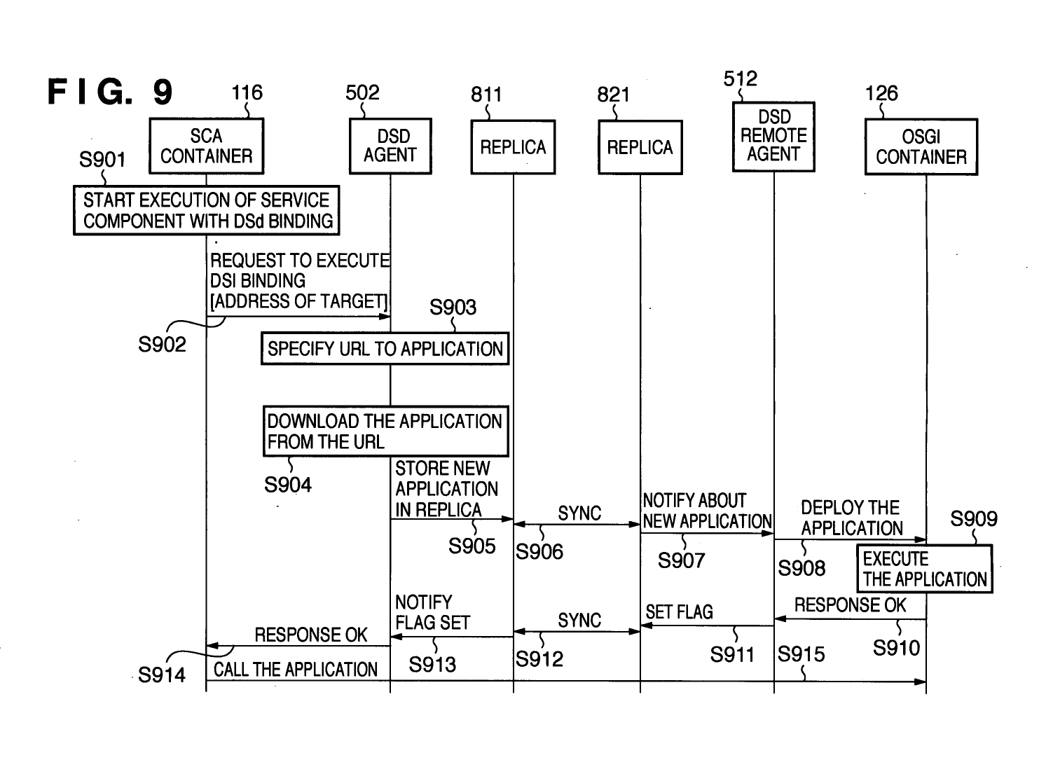

FIG. 9 illustrates exemplary overall operations performed in the configuration described in FIGS. 5 and 8 according to an embodiment. The processor included in each device executes computer programs stored in memory of each device to process these operations. Explanations of the steps in FIG. 9 similar to the steps in FIG. 6 are omitted.

In step S904, the DSD agent 502 downloads the application 522 with reference to the address information. In step S905, the DSD agent 502 stores the downloaded application 522 in the replica 811 in order to deploy the software component on the user terminals 120. In step S906, the replica 811 and the replica 821 are synchronized so that the replica 821 receives the application 522 from the replica 811. In step S907, the replica 821 notifies the DSD remote agent 512 with reference to the target information that a new application 522 has become available. In step S911, the DSD remote agent 512 sets an deployment flag indicating that the application 522 are deployed to the target user terminal 120. In step S912, the replica 811 and the replica 821 are synchronized so that the replica 811 receives the deployment flag. In step S913, the replica 811 informs the DSD agent 502 that the deployment flag is set.

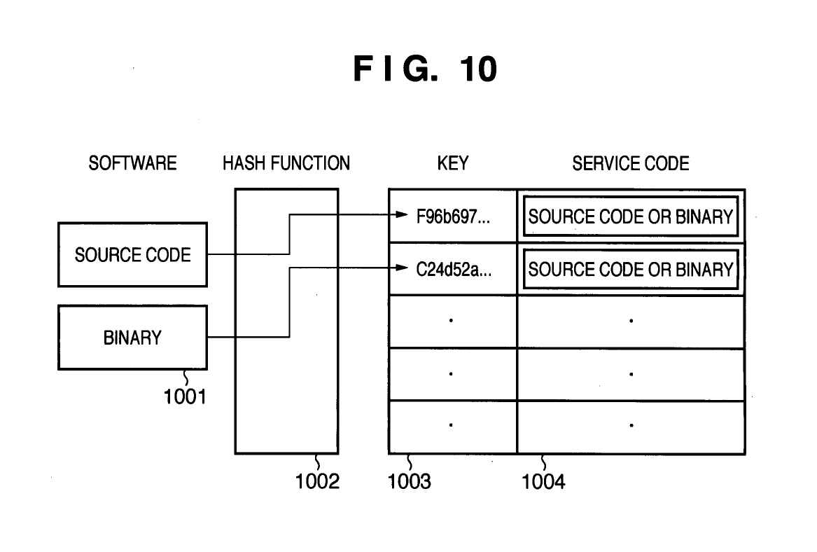

FIG. 10 illustrates a service deployment table, which is a distributed hash table where the binding hash 1002 is used as a key to look up different services 1001. The binding key 1003 can be calculated in various ways, for example using SHA-1 or MD5. The service code 1004 can either consists of binary data such as serialized Java objects or JAR archives, or plain source code such as JavaScript code. As the hash table is completely distributed, multiple SCA containers can add or remove services independently, which is beneficial from a load balancing point of view. The DSD remote agent 502 may have a singleton instance of the service deployment table that is always running and available.

An embodiment of the present invention provides an automatic software component registration. This functionality is useful at time of developing a composite service. According to the existing technologies, developers of business logics (that is, composite services) are expected to know details of software components to be combined to create and execute an intended composite service. Generally, developers of the software component registered on the application warehouse 130 differ from developers of composite services. Thus, the composite service developer creates the service component such as WSDL for the software component registered on the application warehouse 130 when composing the service component. It's inconvenient for composite service developers to create the service component for the software component developed by other developers. The service composite developer may have to find the software specification written by other developers. Thus, it is convenient for composite service developers that the service components (which correspond to the software registered on the application warehouse 130) are automatically registered to the repository 117 in the server 110, synchronized with the software component registration to the application warehouse 130.

If the software component is well formed, the software component can provide enough information to generate service API such as JSR-181, JSR-224. Thus, the Interface part of the software component can be automatically generated. About the Binding part of the software component, the DSD Binding of the software component can be also automatically generated from the address information of the software component and the service API of the application warehouse 130. As a result, it is possible to automatically generate the Interface part and the Binding part of the software component and register the service component to the repository 117.

An embodiment of the present invention provides a dynamic binding setup. Until the service API of the downloaded service component is fixed, it is not possible to create the binding of service reference for the service call. Exceptionally it is possible if the service API can be uniquely determined from various parameters (for example, IP address of the user terminal 120, static TCP port number) that are available for the service caller (SCA container 116) before calling the service component. But it's not the case that, for example, the user terminal 120 locates behind the NAT gateway and the IP address and TCP port are dynamically assigned when deploying the service. In such a case it's hard to determine the service API without this information in advance.

This function is just to add the Service API to the response message sent from the user terminal to the SCA container 116 in steps S608 and S709. This function is realised by adding a new functionality in the DSD remote agent 512 which generate a service API for application. In general, the DSD remote agent 512 notifies the SCA container 116 of information which is required for the SCA container 116 to call the deployed application 522. Then, the SCA container 116 can call the application 522 through this service API.

According to embodiments mentioned above, flexibility of service composition is increased and cost for service development is reduced, and deployment and execution of the composite services become much more flexible, so that value of service composition increases from the viewpoints of developer, provider and consumer of services as an ecosystem. Composite services can easily integrate the software components on the user terminal without the prior deployment of the service. The developers of composite services don't need to take care of the software deployment and deployment on the user terminal. The management cost of software on the user terminal can become lower because dynamic software deployment can let the user terminal to unload the application after the service call has finished. The amount of the memory on the user terminal can become smaller because dynamic software deployment can let the user terminal to unload the software after the service call has finished.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A system for executing a composite service formed by a plurality of software components, the plurality of software components including a first software component and a second software component, the first software component including a reference program through which the second software component is called, the system comprising:
an execution unit configured to execute the first software component;
a specification unit configured to specify address information to be used for downloading the second software component and a target device intended to execute the second software component; and
a deployment unit configured to deploy the second software component downloaded by use of the address information to the target device;
wherein the deployment unit is configured to deploy the second software component while the execution unit is executing the first software component so that the execution unit can call the second software component, and
wherein each software component includes an interface part defining one or more business functions of the software component and a binding part defining access mechanism between the software component and other software components, and the binding part of the first component includes the address information to be used for downloading the second software component.

2. The system according to claim 1, comprising a server and a plurality of user terminals, wherein
the server comprises the execution unit and the specification unit;
each user terminal comprises the deployment unit; and
the target device is selected from the plurality of user terminals.

3. The system according to claim 1, wherein the specification unit is further configured to request the deployment unit to download and deploy the second software component to the target device.

4. The system according to claim 1, wherein the specification unit is further configured to request the deployment unit to download and deploy the second software component to the target device via an application provider providing the second software component.

5. The system according to claim 2, further comprising a database for managing the plurality of software components, wherein
the server is configured to communicate with a first replica of the database;
the target device is configured to communicate with a second replica of the database;
the specification unit in the server is further configured to download the second software component and register the second software component to the first replica; and
the deployment unit in the target device is configured to send a notification to the execution unit after the second software component is synchronized from the first replica to the second replica.

6. The system according to claim 1, wherein the deployment unit is configured to notify the execution unit of information which is required for the execution unit to call the second software component.

7. The system according to claim 1, wherein the target device intended to execute the second software component is specified by a parameter for executing the composite service.

8. The system according to claim 1, wherein the interface part of the first software component is independent of the target device to be specified by a parameter for executing the composite service.

9. The system according to claim 1, further comprising a repository for storing the interface part and the binding part of the plurality of software components, the interface part and the binding part being automatically generated.

10. A method for executing a composite service formed by a plurality of software components, the plurality of software components including a first software component and a second software component, the first software component including a reference program through which the second software component is called, the method comprising:
starting execution of the first software component;
specifying address information to be used for downloading the second software component and a target device intended to execute the second software component;
deploying the second software component downloaded by use of the address information to the target device; and
calling the second software component deployed to the target device during the execution of the first software component,
wherein each software component includes an interface part defining one or more business functions of the software component and a binding part defining access mechanism between the software component and other software components, and the binding part of the first component includes the address information to be used for downloading the second software component.

11. A server for use in a system for executing a composite service formed by a plurality of software components, the plurality of software components including a first software component and a second software component, the first software component including a reference program through which the second software component is called, the server comprising:
an execution unit configured to execute the first software component; and
a specification unit configured to specify address information to be used for downloading the second software component and a target device intended to execute the second software component;
wherein the specification unit is further configured to request the target device to deploy the second software component downloaded by use of the address information while the execution unit is executing the first software component so that the execution unit can call the second software component, and
wherein each software component includes an interface part defining one or more business functions of the software component and a binding part defining access mechanism between the software component and other software components, and the binding part of the first component includes the address information to be used for downloading the second software component.

12. A user terminal for use in a system for executing a composite service formed by a plurality of software components, the plurality of software components including a first software component and a second software component, the first software component including a reference program through which the second software component is called, the user terminal comprising:
a receiving unit configured to receive address information to be used for downloading the second software component;
a deployment unit configured to deploy the second software component downloaded by use of the address information to the user terminal; and
an execution unit configured to execute the deployed second software component when a device which is executing the first software components calls the second software component,
wherein each software component includes an interface part defining one or more business functions of the software component and a binding part defining access mechanism between the software component and other software components, and the binding part of the first component includes the address information to be used for downloading the second software component.

13. The system according to claim 2, wherein the specification unit is further configured to request the deployment unit to download and deploy the second software component to the target device.

14. The system according to claim 2, wherein the specification unit is further configured to request the deployment unit to download and deploy the second software component to the target device via an application provider providing the second software component.

15. The system according to claim 5, wherein the deployment unit is configured to notify the execution unit of information which is required for the execution unit to call the second software component.

16. The system according to claim 15, wherein the target device intended to execute the second software component is specified by a parameter for executing the composite service.

17. The system according to claim 16, wherein the interface part of the first software component is independent of the target device to be specified by a parameter for executing the composite service.

18. The system according to claim 1, further comprising a repository for storing the interface part and the binding part of the plurality of software components, the interface part and the binding part being automatically generated.

19. The server of claim 11, wherein the target device intended to execute the second software component is specified by a parameter for executing the composite service.
